(19) United States
(12) Patent Application Publication
(10) Pub. No.: US 2024/0280684 A1
(43) Pub. Date: Aug. 22, 2024

(54) RELIABLE LOCATION DETERMINATION OF NEARBY DEVICES USING REDUCED POWER OUTPUT

(71) Applicant: QUALCOMM Incorporated, San Diego, CA (US)

(72) Inventors: Avinash SHRIVASTAVA, Hyderabad (IN); Stephen William EDGE, Escondido, CA (US); Bala RAMASAMY, San Marcos, CA (US)

(21) Appl. No.: 18/171,213

(22) Filed: Feb. 17, 2023

(51) Int. Cl. G01S 13/76; H04W 4/06; H04W 64/00

(52) U.S. Cl. CPC G01S 13/765; H04W 4/06; H04W 64/00

(57) ABSTRACT

In some implementations, a first mobile device may communicate with a plurality of mobile devices to form a positioning group, where the communicating comprises exchanging positioning capability information with the plurality of mobile devices, and where the positioning group comprises: a leader device configured to determine an initial position estimate, a validator device configured to determine a validated position estimate, and one or more other devices different than the leader device and the validator device. The first mobile device may send an estimated position of the first mobile device to a monitoring device, where the estimated position of the first mobile device is based at least in part on the initial position estimate, the validated position estimate, or both.

### BACKGROUND

### 1. Field of Disclosure

The present disclosure relates generally to the field of wireless communications, and more specifically to the position determination of an electronic device capable of wireless communications.

### 2. Description of Related Art

Mobile devices, such as tags used to monitor the location of items during shipment or transit, often engage in wireless communications along a route of travel. For example, such mobile devices may periodically send wireless transmissions reporting their estimated location and other information to a remote monitoring device (e.g., server). These wireless transmissions may be communicated via a wireless communication network. Mobile devices may use any of a variety of different techniques to determine their estimated location, and different techniques may have different accuracies and power requirements. For some devices like location reporting tags, minimizing power requirements can be important or critical.

### BRIEF SUMMARY

An example method of providing location determination, according to this disclosure, may comprise communicating with a plurality of mobile devices to form a positioning group, wherein the communicating comprises exchanging positioning capability information with the plurality of mobile devices, and wherein the positioning group comprises: a leader device configured to determine an initial position estimate, a validator device configured to determine a validated position estimate, and one or more other devices different than the leader device and the validator device. The method also may comprise sending an estimated position of the first mobile device to a monitoring device, the estimated position of the first mobile device based at least in part on the initial position estimate, the validated position estimate, or both.

An example method of providing location determination, according to this disclosure, may comprise receiving an indication of a leader device and a validator device of a positioning group, wherein the positioning group comprises: the leader device configured to determine an initial position estimate, the validator device configured to determine a validated position estimate, and one or more other devices different than the leader device and the validator device. The method also may comprise receiving an indication that an attempt by the leader device to determine the initial position estimate has failed. The method also may comprise responsive to receiving the indication that the attempt by the leader device to determine the initial position estimate has failed, initiating a positioning session with the validator device.

An example first mobile device comprising: a transceiver, a memory, one or more processors communicatively coupled with the transceiver and the memory, wherein the one or more processors are configured to communicate with a plurality of mobile devices, via the transceiver, to form a positioning group, wherein the communicating comprises exchanging positioning capability information with the plurality of mobile devices, and wherein the positioning group comprises: a leader device configured to determine an initial position estimate, a validator device configured to determine a validated position estimate, and one or more other devices different than the leader device and the validator device. The one or more processors further may be configured to send an estimated position of the first mobile device to a monitoring device via the transceiver, the estimated position of the first mobile device based at least in part on the initial position estimate, the validated position estimate, or both.

An example location server comprising: a transceiver, a memory, one or more processors communicatively coupled with the transceiver and the memory, wherein the one or more processors are configured to receive, via the transceiver, an indication of a leader device and a validator device of a positioning group, wherein the positioning group comprises: the leader device configured to determine an initial position estimate, the validator device configured to determine a validated position estimate, and one or more other devices different than the leader device and the validator device. The one or more processors further may be configured to receive, via the transceiver, an indication that an attempt by the leader device to determine the initial position estimate has failed. The one or more processors further may be configured to responsive to receiving the indication that the attempt by the leader device to determine the initial position estimate has failed, initiating a positioning session with the validator device.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of an embodiment of a wireless system capable of communication and positioning, referred to herein simply as a positioning system.

FIG. 2 is an illustration of an embodiment of a positioning system architecture having multiple groups of devices, referred to herein as positioning groups, as well as location servers.

FIG. 3 is a signaling flow diagram of process that devices may perform to form a positioning group and designate leader and validator devices, according to an embodiment.

FIGS. 4A-6B are signaling flow diagrams illustrating various processes for reliable location determination of nearby devices using reduced power output, according to some embodiments.

FIG. 7 is a flow diagram of a method of providing reliable location determination using reduced device power, according to an embodiment.

FIG. 8 is a flow diagram of another method of providing reliable location determination using reduced device power, according to an embodiment.

FIG. 9 is a block diagram of an embodiment of a mobile device.

FIG. 10 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 105 may be indicated as 105-1, 105-2, 105-3 etc. or as 105a, 105b, 105c, etc. When referring to such an element using only the first number, any instance of the element is to be understood (e.g., element 105 in the previous example would refer to elements 105-1, 105-2, and 105-3 or to elements 105a, 105b, and 105c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

As previously noted, wireless mobile devices can determine and communicate their location. Such devices may include any of a variety of devices capable of determining their position (e.g., mobile phones, wearable devices, vehicles, etc.). Such devices may also include wireless electronic tags (e.g., affixed to an item) used to monitor the location of an item (e.g., a package, palette, or shipping container) during shipping. Because these mobile devices are frequently battery-powered, the number of times the mobile device can communicate its location may be limited by the amount of power the battery can provide over the course of the device's journey. Such devices therefore have strict power budgets.

Embodiments described herein can address these and other issues by forming a group of nearby devices during travel, enabling devices in the group to leverage location information from another device in the group rather than using power to perform a positioning method to determine their individual locations. In particular, a “leader” device can be chosen to determine its location and shared with other devices in the group. Further, a “validator” device that validate the position of the leader device, to help ensure accuracy. Moreover, according to some embodiments, the positioning method used by the validator device may complement the positioning method used by the leader device, which can help ensure accuracy and robustness of the location determination. During the journey, a group may re-designate devices (e.g., periodically) so that different devices may play the role of leader and validator, thereby spreading the power savings and other benefits to all devices in the group.

Embodiments may therefore provide various potential advantages. For example, devices in the group may benefit from power savings by sharing information to reduce the amount of positioning determinations made by the group as a whole. That is, rather than every device in the group using power to determine its own position independently, one or two devices in the group may determine their positions and share them with the group. Moreover, as noted, the designation of the one or two devices that determine their positions (e.g., leader and validator) may change over the course of a journey to allow all devices in the group to benefit from power savings.

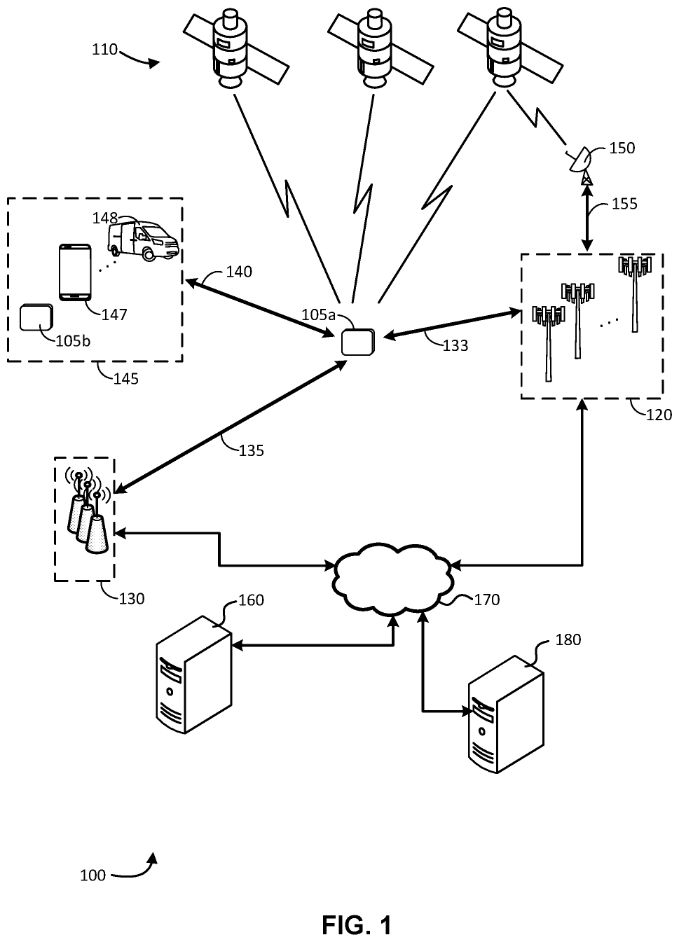

FIG. 1 is a simplified illustration of a wireless system capable of communication and positioning, referred to herein simply as a positioning system 100 in which a mobile device 105a, network function server 160, and/or other components of the positioning system 100 can use the techniques provided herein for providing reliable location determination of nearby devices using reduced power output, according to an embodiment. (That said, embodiments are not necessarily limited to such a system.) The techniques described herein may be implemented by one or more components of the positioning system 100. The positioning system 100 can include: a mobile device 105a; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. In FIG. 1, another mobile device 105b of the same device type as mobile device 105a is illustrated. Techniques for locating the position of mobile device 105a may also apply to mobile device 105b. Mobile devices 105a and 105b may be referred to herein collectively and/or generically as mobile device 105.

In the positioning system 100, mobile device(s) 105 may comprise wireless mobile (e.g., movable) devices capable of determining its position in communicating via one or more wireless networks. Although illustrated as a positioning tag in FIG. 1, a mobile device 105 may include other types of devices. This may include, for example, a mobile phone, laptop, tablet, personal data assistant (PDA), navigation device, Internet of Things (IoT) device, wearable device, In Vehicle communications System (IVS) or other vehicle system/device, or some other portable or moveable device with wireless communication capabilities

Generally put, the positioning system 100 may be capable of enabling communication between the mobile device 105 and other devices, and positioning of the mobile device 105 and/or other devices by the mobile device 105 and/or other devices, or a combination thereof. For example, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions, and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized as communication satellites for a Non-Terrestrial Network (NTN), e.g. where mobile device 105 accesses network 170 via a satellite 110 which in turn accesses the base station 120. This link between satellite 110 and base station 120 may be enabled via NTN gateways 150 (also known as “gateways,” “earth stations,” or “ground stations”), which can send and receive wireless signals from the satellite 110, and further communicate with the base station 110 via a wireless and/or wired communication link 155. In some embodiments, NTN gateways 150 may function as DUs of a base station 120, as described previously. Satellites 110 may then support NTN-based positioning and may functionally operate as TRPs (or TPs) of a network (e.g., LTE and/or NR network). In particular, reference signals such as positioning reference signals (PRS) that are transmitted by satellites 110 to support NTN-based positioning may be similar to reference signals transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other devices 145, which may be mobile or fixed. As illustrated, other mobile devices may include, for example, another mobile device 105b of the same device type, a cellular device 147 (e.g., smart phone, tablet, laptop, etc.), a vehicle 148 (e.g., shipping/transit vehicle, such as a cargo ship, semi-trailer truck, delivery van, etc.), or a combination thereof. Wireless signals from devices 145 (which may include RF signals 140 used for communication) may be used for positioning of the mobile device 105 and may comprise RF signals using, for example, Bluetooth® (including Bluetooth Low Energy (BLE)), IEEE 802.11x (e.g., Wi-Fi®), Ultra Wideband (UWB), IEEE 802.15x, sidelink (e.g., as defined in LTE and NR by the standards), or a combination thereof. Devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105. In some embodiments, for example, the external client 180 may comprise a monitoring server configured to monitor the location of devices including the mobile device 105. Additionally or alternatively, the external client 180 may obtain and provide the location of mobile device 105 to an emergency services provider, government agency, etc.

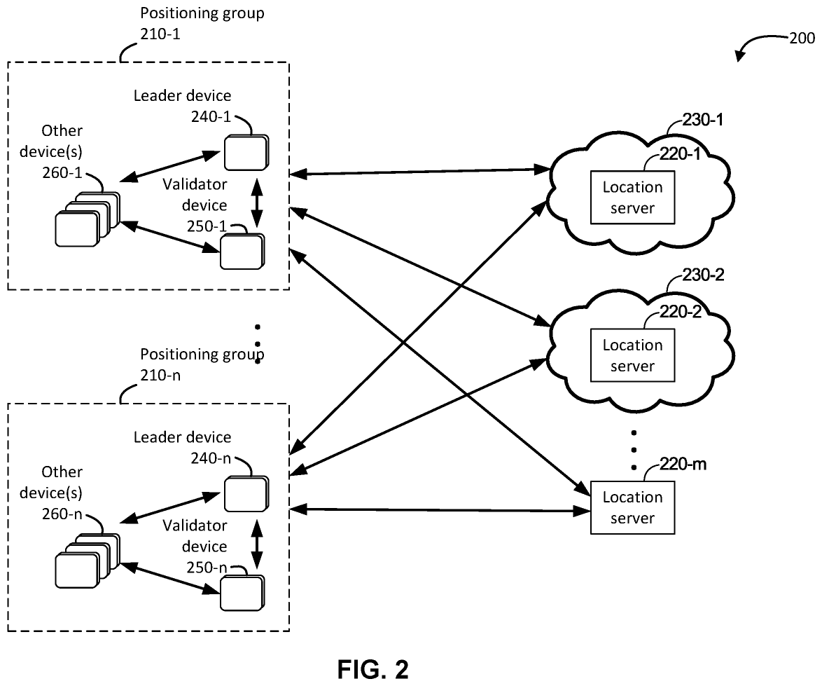

According to some embodiments, mobile devices 105 (e.g., devices that serve as shipment tags) may be grouped with other mobile devices that may not necessarily be a part of the same network. That is, a single group may have multiple mobile devices 105 that have different service providers. This may mean that devices in a single group may communicate with different location servers and/or report to different monitoring devices. An example of this is illustrated in FIG. 2.

FIG. 2 is an illustration of a positioning system architecture 200 having multiple groups of devices, referred to herein as positioning groups 210, as well as location servers 220. In this example, there are n positioning groups (200-1 to 200-n) and m location servers (220-1 to 200-m). Further, in this example, each positioning group 210 is communicatively coupled with each location server 220 (as indicated by double-sided arrows). It will be understood, however, that embodiments may differ from the example illustrated in any number of ways, including having fewer location servers 220 and/or positioning groups 210 than illustrated, having different connectivity between device groups 210 and location servers 220, or some combination thereof.

In FIG. 2, location servers 220-1 and 220-2 are associated with different wireless networks 230-1 and 230-2. These wireless networks 230 may comprise different service providers, e.g., different cellular or other communication networks with which device groups 210 may communicate. These wireless networks 230 may be connected to the Internet and/or other communication networks. Further, as illustrated, the location servers 220-1 and 220-2 may be executed within (e.g., provided by) the wireless networks 230. That said, some location servers 220 may not necessarily be executed within a wireless network, as illustrated by location server 220-m. Such location servers therefore may not necessarily be used for RAT-based positioning provided by a wireless network 230, although they may in some embodiments.

As described in further detail hereafter, each positioning group 210 may comprise a group of devices that are traveling or will travel along a same route of travel—at least for some period of time. The devices may, for example, be located on a single pallet, vehicle, shipping container, or the like. Each group may comprise a leader device 240, a validator device 250, and one or more other devices 260. Some embodiments may employ more than one validator device, depending on desired functionality.

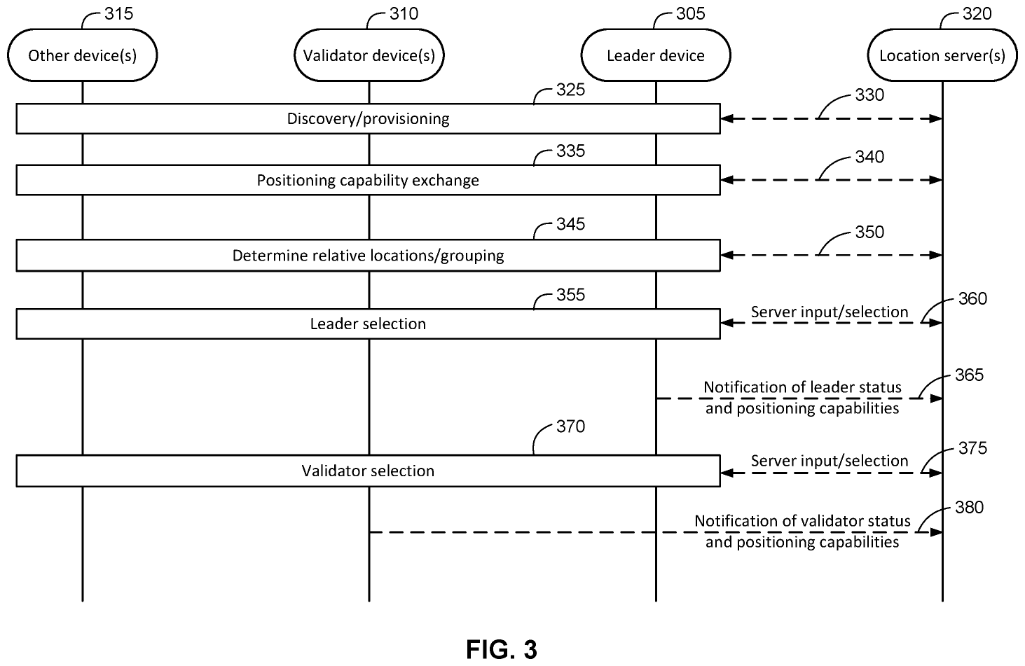

As noted, a positioning group 210 may collectively save power by having the leader device 240 and validator device 250 determine their positions and share their positions with other devices 260 in the device group 210. Depending on the circumstances, a positioning group 210 may comprise devices of different device types and capabilities. In one embodiment, the leader device 240 and validator device 250 may be selected based on their capabilities. Additional details are provided hereafter with regard to FIG. 3.

FIG. 3 is a signaling flow diagram of process that devices may perform to form a positioning group and designate leader and validator devices. Devices 305, 310, and 315 that correspond with respective devices 240, 250, and 260 in FIG. 2 and/or mobile devices 105 of FIG. 1. It can be noted that devices are illustrated separately in FIG. 2 as leader device 305, one or more validator devices 310, and other device(s) 315 to help illustrate separate functionality. However, at the beginning of the process (e.g., performing functionality at stage 325), a leader device 305 and validator device(s) 310 may not yet be designated as such. Dashed lines represent optional functionality. Thus, as can be seen, all interactions with one or more location servers 320 illustrated in FIG. 3 (which may correspond with location servers 220 in FIG. 2 and/or location server 160 in FIG. 1.) may be optional and may be used as needed in implementation.

At stage 325, devices 305, 310, and 315 undergo a discovery and provisioning process in which devices discover each other and are provisioned to embark on a journey. According to some embodiments, the actions at stage 325 may be triggered by an application-layer event, such as a user using an application on a wireless device or on a server communicatively coupled with the devices 305, 310, and 315 to put the devices 305, 310, and 315 in a “journey” mode, at which point the devices 305, 310, and 315 may initiate the discovery process to discover nearby devices with which they can form a positioning group. In other embodiments, the devices 305, 310, and 315 may autonomously determine to initiate the discovery and provisioning process, e.g. as a consequence of detecting motion of the devices 305, 310, and 315 using inertial sensors or due to detecting an occurrence of a time-based trigger event such as detecting the occurrence of a particular time instant that was previously configured in the devices 305, 310, and 315 by an external server or external client. The discovery and provisioning process may comprise, for example, the devices 305, 310, and 315 sending and receiving wireless messages to identify themselves and other candidate devices with which a positioning group may be formed. Communications between devices may be via sidelink signaling (e.g. LTE or NR sidelink signaling) or a different wireless technology such as IEEE 802.11 Wi-Fi, Bluetooth, etc., or a combination thereof. And thus, the discovery process may be performed in accordance with any governing standards applicable to the wireless technology used.

As indicated at arrow 330, the location server(s) 320 optionally may send and/or receive information during the discovery/provisioning stage 325. This may include: the location server(s) 320 receiving information indicative that the one or more of the devices 305, 310, and 315 that are being provisioned are embarking on a journey; the location server(s) 320 providing information to the devices 305, 310, and 315 related to the journey; the location server(s) 320 providing information to the devices 305, 310, and 315 to help facilitate the discovery process (e.g., indicate nearby devices with which a device may communicate, based on known device location); or a combination thereof.

At stage 335, the devices 305, 310, and 315 may engage in a positioning capability exchange. The positioning capability exchange may involve devices communicating their capabilities for determining their position with other devices. These capabilities may include, for example, types of positioning a device can perform, such as positioning utilizing NR sidelink signaling, LTE sidelink signaling, Wi-Fi, cellular network, GNSS, sensors (e.g., camera-based, dead reckoning, etc.), or the like, as well as information regarding accuracy, reliability, and/or other information regarding each positioning type. According to some embodiments, the positioning capability exchange may further include the exchanging of other information, such as device type, battery capabilities (e.g., battery life, status of charge, etc.), communication capabilities, travel information, or the like. Again, the location server(s) 320 optionally may be involved, as indicated at arrow 340. The location server(s) 320 may, for example, provide capability information to one or more of the devices 305, 310, and 315, indicating the types of network-based positioning and/or measurements the location server(s) 320 may be capable of supporting (time difference of arrival (TDOA), round-trip time (RTT), angle of arrival (AOA), angle of departure (AOD), etc.).

At stage 345, devices 305, 310, and 315 can then determine their relative locations (e.g. a range and bearing between pairs of devices and/or their location coordinates relative to some common location (or common reference point) such as a location of one of the devices) and form a positioning group. The determination of relative locations can help the devices 305, 310, and 315 determine which devices should be in the positioning group. A device that travels away from other devices or is beyond a threshold distance from other devices, for example, may be excluded from the positioning group. If journey information is exchanged, devices may be grouped based on having the same or similar journeys. The determination of relative locations may involve performing ranging between devices and/or performing other positioning methods. As shown by arrow 350, the location server(s) 320 optionally may be involved. Such involvement may comprise assisting with location determination of one or more of the devices 305, 310, and 315, for example.

At stage 355, leader selection is performed. Here, the devices 305, 310, and 315 (with optional input from the location server(s) 320, as indicated at arrow 360) may choose the leader device 305 for the positioning group—at least for a portion of the journey that the positioning group will make. (As explained hereafter, the positioning group may select different leader devices at different points in the journey.) Further, according to some embodiments, the leader device 305 may notify the location server(s) 320 of its designation as the leader device, as indicated at arrow 365.

Leader selection may be based on any of a number of factors, depending on desired functionality. For example, because the leader device 305 will determine its position throughout the journey more frequently than validator device(s) 310 and/or other device(s) 315, it will likely use more power. Thus, one factor when determining the leader device 305 may be a battery capacity and/or status. Other factors may comprise positioning types supported, positioning accuracy, ability to communicate with nearby devices, and/or other capabilities. Thus, in some embodiments, a device with a higher remaining battery capacity, a capability to support more positioning types, a higher positioning accuracy, and/or an ability to communicate with more nearby devices than other devices may be determined as the leader device 305.

At stage 370, the devices 305, 310, and 315 perform validator selection in a manner similar to leader selection. That is, the validator device(s) 310 may be selected based on battery capacity and/or capabilities (and optionally based on input from the location server(s) 320, as indicated at arrow 375). Moreover, the validator device(s) 310 may notify the location server(s) 320 of its designation as validator device, as indicated at arrow 380. Based on desired functionality, however, more than one validator device 310 may be selected, according to some embodiments. In some embodiments, a device with a capability to support more positioning types, and/or a higher positioning accuracy than other devices may be determined as a validator device 310.

According to some embodiments, the selection of the leader device 305 and validator device(s) 310 may take any of a number of different approaches. According to one approach, for example, the leader device 305 may be selected as the device having a least capability (or a limited capability) but possibly high battery capacity. In this approach, a validator device 310 may be selected as the device having the most capability. This way, the validator device 310 can validate a position obtained by the leader devices 305 using its broad capabilities to determine an accurate position. According to some embodiments, the validator device 310 can reduce its positioning capability (and, therefore, power usage) after determining a certain number of positions obtained by the leader device 305 are accurate (e.g., within a threshold).

According to another approach, the leader device 305 may be selected as the device having the best (or most) positioning capabilities for the journey (or portion of the journey for which the leader device 305 will be leader). In this approach, a validator device 310 may be selected as one that can provide complementary positioning functionality. If the leader device 305 supports GNSS positioning, for example, the validator device 310 may support an alternate type of positioning (e.g., Wi-Fi-based positioning, cellular-based positioning, NTN-based positioning etc.). Additionally or alternatively, the validator device 310 may use different (e.g. complementary) forms of the same type of positioning. For example, if the leader device 305 uses cellular-based positioning using RTT measurements, the validator device 310 may use cellular-based positioning using TDOA and/or AOA measurements. Other forms of complementary functionality may be identified for the selection of leader device 305 and validator device 310.

In some instances, a positioning group may be formed by devices having the same capabilities. Even so, a leader device 305 and validator device 310 may still be chosen to have complementary functionality. If both devices are equipped for performing two different types of position, for example, each may select a different type to use to perform positioning during the journey. Moreover, different devices may get different wireless reception for signals used in different positioning methods (e.g., GNSS, cellular/Wi-Fi, etc.), and may be selected as leader device 305 or validator device 310 based on such wireless reception.

A disassociation or termination of a group may be based on different types of events, depending on desired functionality. According to some embodiments, a group may be terminated upon detected arrival at a destination (e.g., the final point in a journey taken by all devices in the group). Additionally or alternatively, a group may be terminated upon detection of movement of devices within a group relative to each other (e.g., movement away from each other) and/or detection of a distance between devices exceeding a threshold level. A single device may be removed from a group if the device is detected (e.g., by the leader device or another device in the group) to be moving away from other devices in the group and/or exceeds a threshold distance from other devices in the group (e.g., a center point of the group or a nearest device). Likewise, a device may be added to a positioning group during a journey (e.g., subsequent to initial group formation) if detected by other devices in the group (e.g., the leader) during the journey.

As noted, leader and/or validator selection may occur more than once. For long journeys, for example, the role of leader and/or validator device may be assumed by different devices in a positioning group. A single device may therefore play the role of leader device, validator device, and other device, at different times over the course of a journey along which the positioning group travels. These times may include predetermined or prescheduled times, and/or times triggered by a triggering event. An event triggering the selection of a new leader device may include the current leader device detecting a low battery level (e.g., below a threshold), an inability to perform position determination, and/or inability to communicate with a location server, or a combination thereof. A similar set of triggering events may be used for the selection of a new validator device, which may be determined at the same time and/or at different times than the leader device. The selection of the leader device and/or validator device during a journey may involve the functionality described with respect to items 355-380 in FIG. 3, or may involve a different process, such as the outgoing leader or validator device selecting the new leader or validator device.

Thus, the process show in FIG. 3 and described above may be repeated periodically (e.g. during a journey) or when certain trigger events occur (e.g., such as leader device 305 or validator device(s) 310 running low on battery capacity or devices moving away from other devices in the positioning group). For any repetition of the process in FIG. 3, a new leader device 305 and/or new validator device(s) 310 may be determined and/or the devices belonging to the positioning group may be changed.

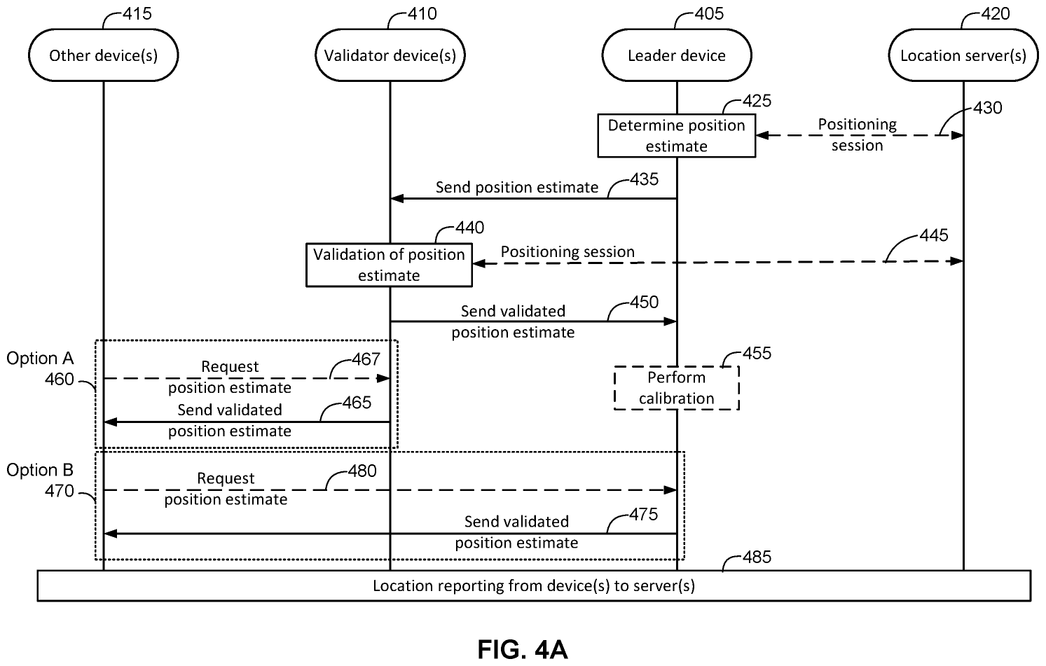

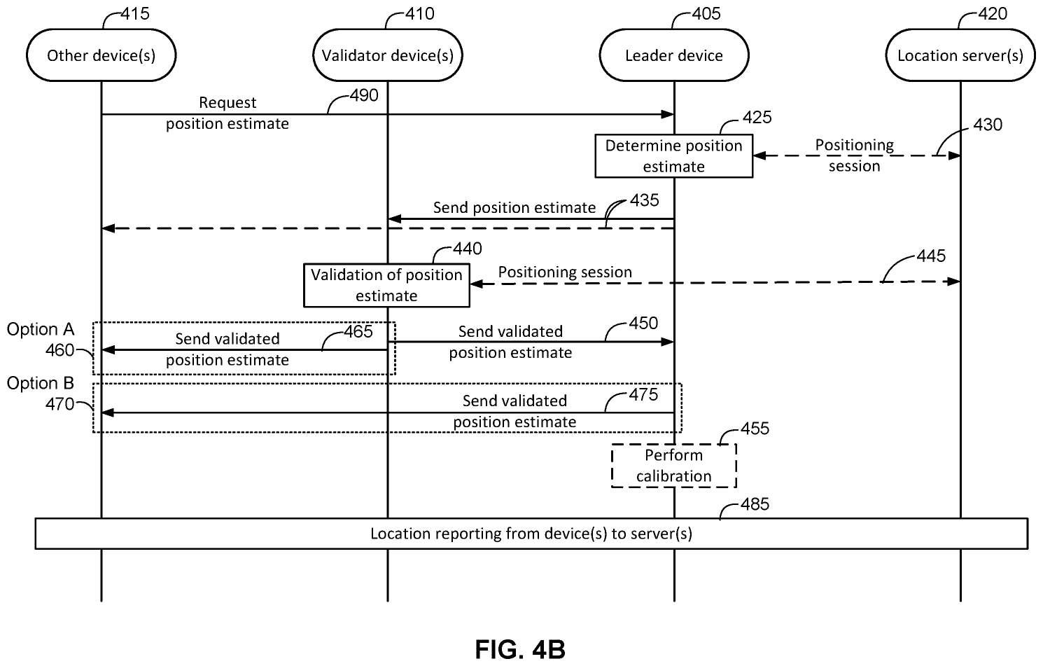

Depending on desired functionality, positioning performed by the leader device can be responsive to a request from a location server, validator, or other device. Additionally or alternatively, the leader device may perform positioning at various times during a journey (e.g., responsive to triggering events, in accordance with a schedule, etc.), then provide the position to the other devices (e.g., upon request, in accordance with the schedule, etc.). Depending on desired functionality, devices may enter a low-power mode when not communicating or performing positioning. According to some embodiments, devices may utilize low-power signaling to help ensure low-power usage when communicating with other devices. The diagrams illustrated in FIGS. 4A-6B provide some examples of how such positioning may be performed.

FIG. 4A is a signaling flow diagram illustrating a basic process in which a leader device 405 performs positioning that is validated by validator device(s) 410 and provided to other device(s) 415. As explained in more detail hereafter, location reporting may be provided to location server(s) 420, which may optionally be utilized for positioning of the leader device 405 and/or validator device(s) 410.

At block 425, the leader device 405 determines its position estimate. This may be in accordance with a predetermined schedule, a triggering event, or the like. Depending on the type of positioning performed by the leader device 405, the leader device 405 may conduct a positioning session with the location server(s), as indicated by arrow 430. Upon obtaining a position estimate, the leader device 405 may then send it the position estimate the validator device(s) 410 to verify the position estimate, as indicated at arrow 435.

At block 440, the validator device(s) 410 validate the position estimate provided by the leader device 405 and provide the validated position estimate to the leader device 405, as indicated at arrow 450. Depending on desired functionality, this validation may comprise determining an accurate position of the validator device(s) 410, then determining a corresponding validated position estimate for the leader device 405 (e.g., based on a known position of the validator device(s) 410 relative to the leader device 405, which is then provided to the leader device 405. Alternatively, this may comprise providing the leader device 405 with the position estimate of the validator device(s) 410, and the leader device 405 can then determine its location based on its position but if to the validator device(s) 410. According to some embodiments, to save on overhead, the validator device(s) 410 may not provide a validated position estimate to the leader device 410 unless the validator device(s) 410 determined that the position estimate of the leader device 405 provided at arrow 435 is beyond a threshold distance from the validated position estimate determined at block 440. As indicated at block 455, the leader device 405 may optionally calibrate one or more sensors and/or algorithms based on the validated position estimate, to help increase the accuracy of future positioning by the leader device 405.

After the validated position estimate is provided to the leader device 405, both the leader device 405 and validator device(s) have the validated position estimate that can be provided to the other device(s) 415. As such, there are different options regarding how the validated position estimate may be provided to the other device(s) 415. According to a first option (Option A 460), the validated position estimate may be provided by the validator device(s) 410, as indicated with arrow 465. This position may be provided to the other device(s) 415 in accordance with a predetermined schedule, and/or may be provided in response to a request by one or more of the other device(s) 415, as indicated at arrow 467. According to a second option (Option B 470), the validated position estimate may be provided by the leader device 405, as indicated with arrow 475. Again, this position may be provided to the other device(s) 415 in accordance with a predetermined schedule, and/or may be provided in response to a request by one or more of the other device(s) 415, as indicated at arrow 480. Depending on desired functionality, the validated position estimate provided by the validator device(s) 410 in Option A 460 and/or the leader device 405 in Option B 470 may be broadcast or groupcast to the other device(s) 415 or provided individually using unicast communications.

Finally, at block 485, devices 405, 410, and/or 415 may provide location reporting to the location server(s) 420. Again, this may be responsive to a request by the location server(s) 420 and/or in accordance with a predetermined schedule. In the location reporting, each device may report its position (e.g., based on the validated position estimate and a known relative position to the leader device 405). Depending on desired functionality, the position may include a timestamp of the time at which the validated position estimate was made (which may not be reflective of a current position of the respective device). This may be sufficient for monitoring the location of the devices 405, 410, and/or 415 by the location server(s) 420 over the course of a journey made by the devices 405, 410, and/or 415.

FIG. 4B is a signaling flow diagram illustrating a variation on the flow diagram of FIG. 4A. In FIG. 4B, operations 425-485 echo corresponding operations in FIG. 4A described previously. However, the process illustrated in FIG. 4B illustrates an on-demand functionality in which the performance of operations 425-475 are responsive to a request from one or more other devices 415 sent to the leader device 405, illustrated by arrow 490. Additional variations of FIG. 4B from FIG. 4A include the leader device 405 optionally sending the position estimate directly to the requesting other device(s) 415 (at arrow 435) and omission of requests by the other device(s) 415 in Option A 460 and Option B 470 (because the position estimate has already been requested by the other device(s) 415 at arrow 490).

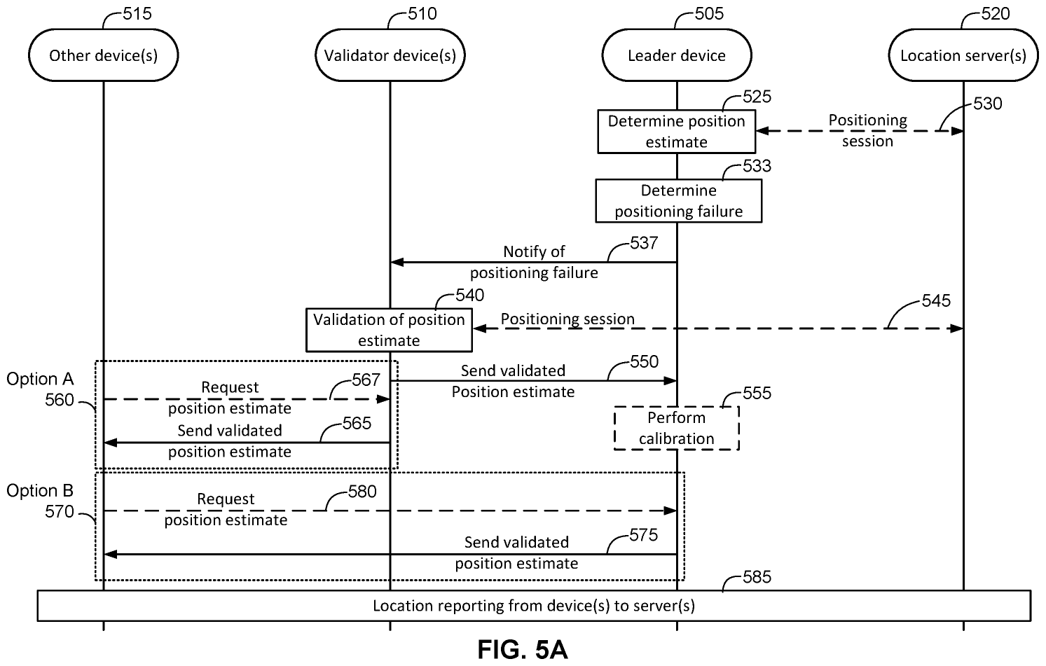

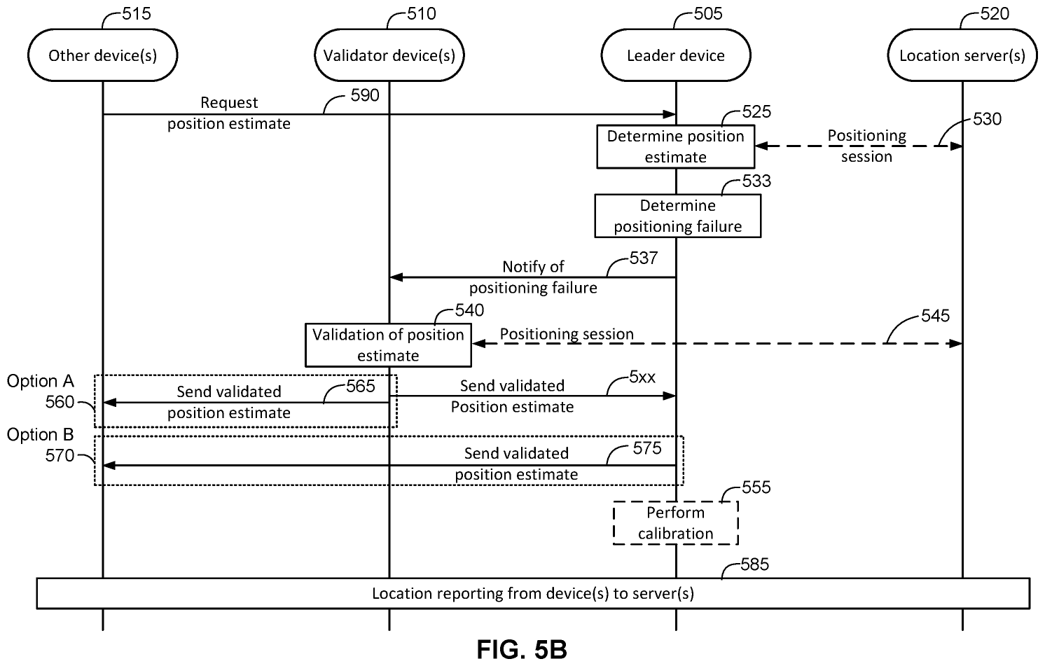

FIG. 5A is a signaling flow diagram illustrating a variation of the process illustrated in FIG. 4A. In this variation, rather than using validator device(s) 510 to validate all positions determined by the leader device 505, they may instead be used when the leader device 505 determines a positioning failure (indicated at block 533), in which case the leader device 505 notifies the validator devices 510 of the positioning failure (indicated at arrow 537). Other functionality of operations 525-585 illustrated in FIG. 5A may echo corresponding operations 425-485 in FIG. 4A, described above.

The determination of a positioning failure at block 533 may vary, depending on desired functionality. According to some embodiments, the leader device 505 determines a positioning failure has occurred when a positioning method used in the determination of the position estimate at block 525 results in a position estimate having less than a threshold accuracy and/or threshold confidence level. These accuracy and/or confidence levels may be application-specific, and may therefore be set such that applications requiring a high accuracy/confidence level result in more frequent validation than applications requiring lower accuracy/confidence levels. Additionally or alternatively, the leader device 505 may determine a positioning failure has occurred when a positioning method used in the determination of the position estimate at block 525 cannot be performed or otherwise does not result in a position estimate. This can occur, for example, if the leader device 505 attempts to perform GNSS positioning while traveling through a tunnel, resulting in little or no RF signal reception from GNSS satellites.

FIG. 5B is a signaling flow diagram illustrating a variation on the flow diagram of FIG. 5A. In FIG. 5B, operations 525-585 echo corresponding operations in FIG. 5A described previously. However, similar to the process illustrated in FIG. 4B, the process illustrated in FIG. 5B includes an on-demand functionality in which the performance of operations 525-575 are responsive to a request from one or more other devices 515 sent to the leader device 405, illustrated by arrow 490. Additional variations of FIG. 5B from FIG. 5A include the omission of requests by the other device(s) 515 in Option A 560 and Option B 570 (again, because the position estimate has already been requested by the other device(s) 515 at arrow 590).

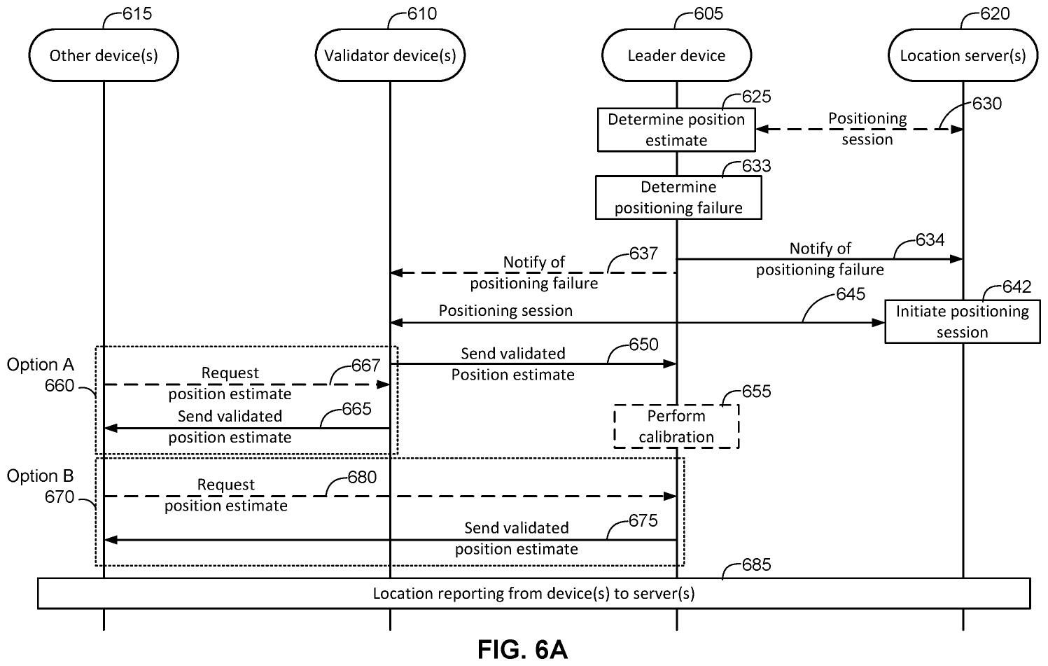

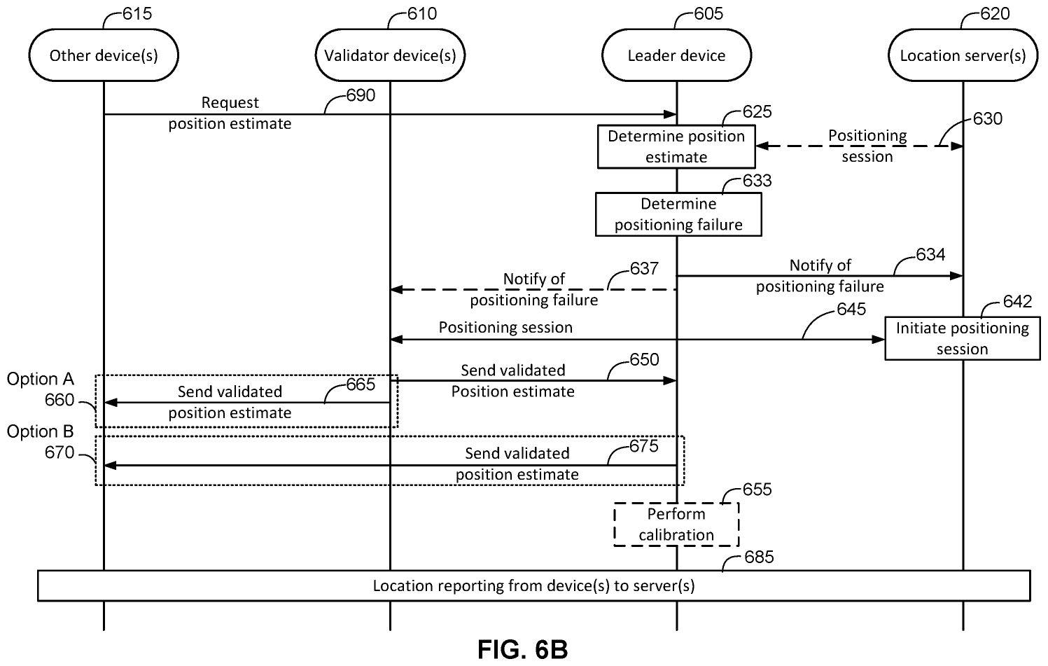

FIG. 6A is a signaling flow diagram illustrating a variation of the process illustrated in FIG. 5A. In this variation, rather than (or in addition to) notifying validator device(s) 610 of a positioning failure (optional functionality shown by dashed arrow 637), the leader device 605 notifies location server(s) 620 of the positioning failure, as indicated at arrow 634. In response, location server(s) 620 can perform the functionality at block 642 by initiating a positioning session (arrow 645) with the validator device(s) 610. (E.g., as opposed to the validator device(s) 510 optionally initiating a positioning session 545 with location server(s)520, as shown in FIG. 5A.)

FIG. 6B is a signaling flow diagram illustrating a variation on the flow diagram of FIG. 6A. In FIG. 6B, operations 625-685 echo corresponding operations in FIG. 6A described previously. However, similar to the process illustrated in FIGS. 4B and 5B, the process illustrated in FIG. 6B includes an on-demand functionality in which the performance of operations 625-675 are responsive to a request from one or more other devices 615 sent to the leader device 605, illustrated by arrow 690. Additional variations of FIG. 6B from FIG. 6A include the omission of requests by the other device(s) 615 in Option A 660 and Option B 670 (again, because the position estimate has already been requested by the other device(s) 615 at arrow 690).

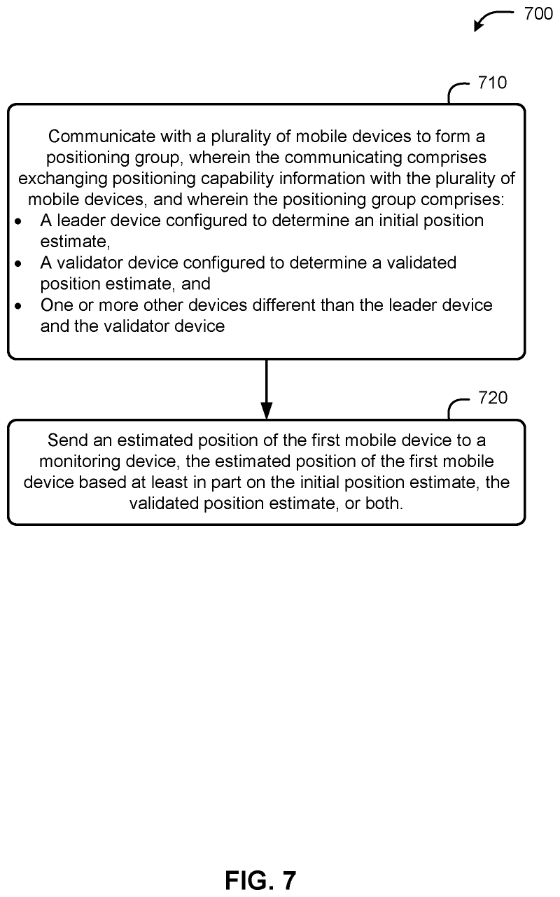

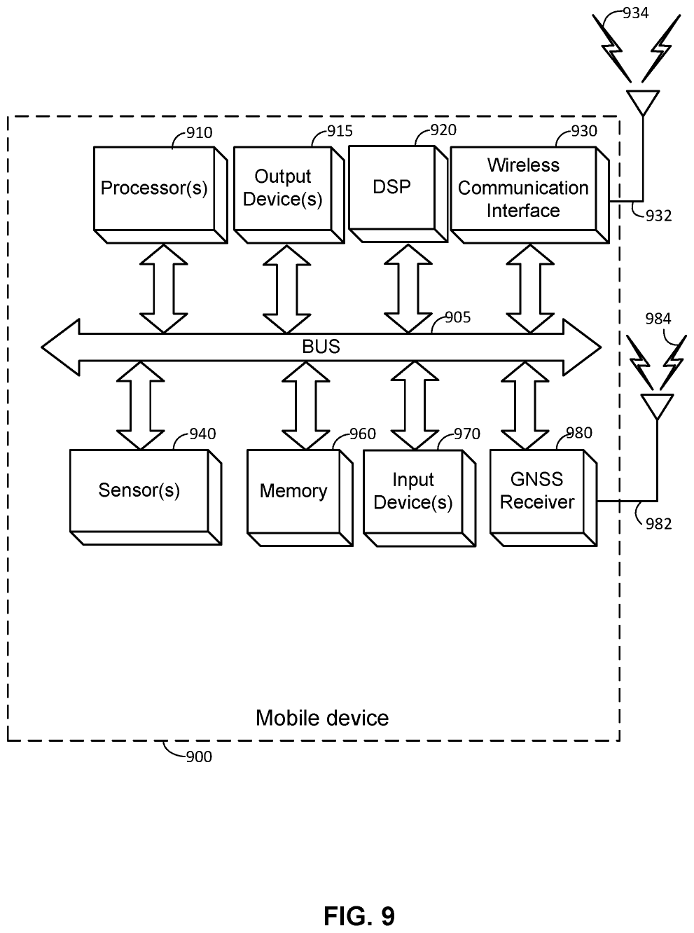

FIG. 7 is a flow diagram of a method 700 of providing location determination (e.g., reliably, using reduced device power), according to an embodiment. As with other figures herein, FIG. 7 is provided as a non-limiting example, and other embodiments may add, remove, rearrange, or otherwise alter the method 700 illustrated in FIG. 7. The operations shown in the blocks in FIG. 7 may be performed by a mobile device (e.g. a mobile device 105), and, as described hereafter, the mobile device may be selected as the leader device, validator device, or other device in a positioning group. Example hardware and/or software components of a mobile device are described hereafter with regard to FIG. 9.

At block 710, the functionality comprises communicating with a plurality of mobile devices to form a positioning group, wherein the communicating comprises exchanging positioning capability information with the plurality of mobile devices, and wherein the positioning group comprises: a leader device configured to determine an initial position estimate, a validator device configured to determine a validated position estimate, and one or more other devices different than the leader device and the validator device. As described previously, devices may select the leader device and/or validator device among themselves (e.g., based on a common set of rules for the selections). Additionally or alternatively, devices may receive input from a server (e.g., location server) regarding which devices to select as leader and/or validator.

As provided in the above-discussed embodiments, the method 700 may include additional operations. For example, according to some embodiments, communicating with the plurality of nearby mobile devices to form the positioning group may comprise determining relative positions of the first mobile device, each mobile device in the plurality of nearby mobile devices, or both. These relative positions may be relative to each other or to a common reference point, for example. According to some embodiments, communicating with the plurality of nearby mobile devices may be based on sidelink signaling (e.g. NR or LTE sidelink signaling). Further, according to some embodiments, the leader device and the validator device maybe respectively selected as the leader device and the validator device of the positioning group based at least in part on the respective positioning capabilities of the leader device and the validator device. In such embodiments, the validator device may be capable of performing more types of positioning methods than the leader device. Moreover, in some embodiments, the validator device may be the most capable device (e.g., the device capable of performing the largest number of positioning methods of a group) and the leader device may be the least capable device (e.g., the device capable of performing the fewest number of positioning methods). In other embodiments, the leader device may be the most capable device or the device with greatest remaining battery capacity or both and the validator device may be a device with positioning capabilities that are complimentary to (e.g. different than) those of the leader device. Again, the designation of leader and validator devices may change over the course of a journey made by the positioning group.

Means for performing functionality at block 710 may comprise a bus 905, processor(s) 910, digital signal processor (DSP) 920, wireless communication interface 930, sensor(s) 940, memory 960, GNSS receiver 980, and/or other components of a mobile device 900, as illustrated in FIG. 9 and described in more detail below.

At block 720, the functionality comprises sending an estimated position of the first mobile device to a monitoring device, the estimated position of the first mobile device based at least in part on the initial position estimate, the validated position estimate, or both. Here, the mobile device may comprise a location server or other remote device. As noted, in some embodiments, a location server may be implemented within a cellular network. As noted, depending on desired functionality, the first mobile device may comprise the leader device, validator device, or other device within the positioning group.

According to some embodiments, the first mobile device may implement different functions when selected as the leader device. For example, in some embodiments in which the first mobile device comprises the leader device, the method 700 may further comprise attempting to determine the initial position estimate, sending, to the validator device, a result of the attempt to determine the initial position estimate, and receiving a validated position estimate (e.g., from the validator device of location server). In such embodiments, a result of an attempt to determine the initial position estimate may comprise the initial position estimate, or an indication that the attempt to determine the initial position estimate has failed. If the result of the attempt to determine the initial position estimate comprises the initial position estimate, the method may further comprise sending the initial position estimate to the one or more other devices, sending the validated position estimate to the one or more other devices, or both. Additionally or alternatively, if the result of the attempt to determine the initial position estimate comprises the initial position estimate, then sending the result to the validator device may be responsive to a determination that a confidence level of the initial position estimate is below a threshold confidence level.

The first mobile device comprising a leader device additionally or alternatively may perform one or more functions. Some embodiments of the method 700 may comprise attempting to determine the initial position estimate responsive to receiving a position request from the one or more other devices. According to some embodiments, the method 700 may comprise performing a calibration of one or more sensors, one or more algorithms, or both, of the first mobile device based at least in part on the validated position estimate. Additionally or alternatively, in embodiments in which the first mobile device comprises the leader device, the method may further comprise attempting to determine the initial position estimate, sending, to a location server, a result of the attempt to determine the initial position estimate, and receiving a validated position estimate from the validator device. Additionally or alternatively, to determine the initial position estimate, the leader device may be configured to conduct a positioning session with a location server.

For instances in which the first mobile device comprises the validator device, the first mobile device may perform one or more functions alternative to those performed by a leader device. For example, according to some embodiments in which the first mobile device comprises a validator device, the method 700 may further comprise receiving, from the leader device, a result of an attempt to determine the initial position estimate, determining the validated position estimate, and sending the validated position estimate to the leader device, the one or more other devices, or a combination thereof. According to some embodiments, sending the validated position estimate to the one or more other devices may be responsive to receiving a position request from the one or more other devices. According to some embodiments, the initial position estimate is determined using a first positioning method, and determining the validated position estimate may comprise using a second positioning method different than the first positioning method. According to some embodiments, determining the validated position estimate may comprise conducting a positioning session with a location server. In such embodiments, the method 700 may further comprise initiating the positioning session with a location server. According to some embodiments in which the result of an attempt to determine the initial position estimate comprises an indication that the attempt to determine the initial position estimate has failed, the method may further comprise initiating the positioning session with a location server responsive to receiving the indication that the attempt to determine the initial position estimate has failed.

In some instances, the first mobile device may comprise one of the one or more other devices, in which case the first mobile device may implement one or more alternative operations. For example, the first mobile device may send a position request to the leader device, the validator device, or both. In such instances, sending the position request may occur prior to an attempt to determine the initial position estimate by the leader device. Additionally or alternatively, sending the position request may be responsive to receiving a request for the position of the first mobile device from the monitoring device. According to some embodiments, communicating with the plurality of nearby mobile devices to form the positioning group comprises determining a relative position of the first mobile device relative to the leader device, the validator device, or both, wherein the estimated position of the first mobile device is based at least in part on the relative position of the first mobile device.

Means for performing functionality at block 720 may comprise a bus 905, processor(s) 910, DSP 920, wireless communication interface 930, sensor(s) 940, memory 960, GNSS receiver 980, and/or other components of a mobile device 900, as illustrated in FIG. 9 and described in more detail below.

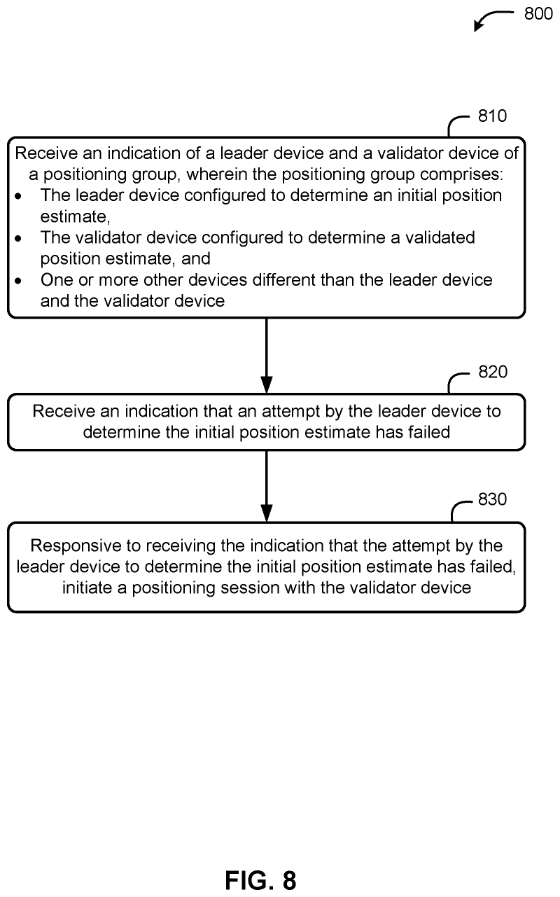

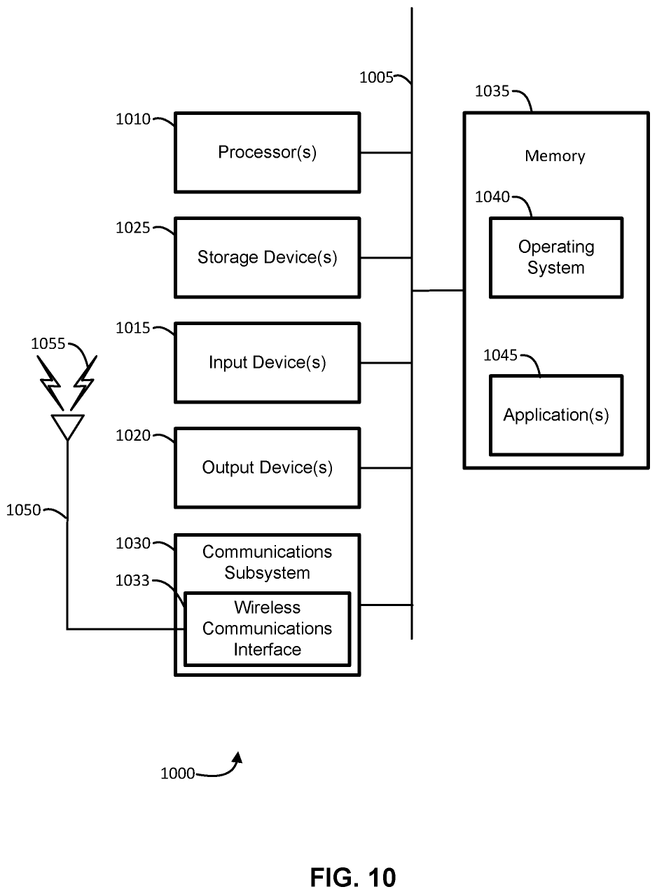

FIG. 8 is a flow diagram of another method 800 of providing location determination (e.g., reliably, using reduced device power), according to an embodiment. Here, the operations shown in the blocks in FIG. 8 may be performed by a location server. Example hardware and/or software components of a computer system that may be used to execute a location server are described hereafter with regard to FIG. 10.

At block 810, the functionality comprises receiving an indication of a leader device and a validator device of a positioning group, wherein the positioning group comprises the leader device configured to determine an initial position estimate, the validator device configured to determine a validated position estimate, and one or more other devices different than the leader device and the validator device. As described above with respect to FIG. 3, these indications may unfounded leader and validator devices themselves. Alternatively, the indication of both leader and validator device may come from the leader device or some other positioning device and the group.

Means for performing functionality at block 810 may comprise a bus 1005, processor(s) 1010, communications subsystem 1030 (which may include wireless communications interface 1033), memory 1035, operating system 1040, application(s) 1045, and/or other components of a computer system 1000, as illustrated in FIG. 10 and described in more detail below.

At block 820, the functionality comprises receiving an indication that an attempt by the leader device to determine the initial position estimate has failed. As described with respect to FIGS. 6A and 6B, this notification may come from the leader device. Moreover, the leader device's attempt to determine an initial position estimate may be made based on a request from the location server or another device in the positioning group. The position estimate request to the leader device from another device and the positioning group may be prompted by a request from the location server for a position estimate of that other device. As such, some embodiments may comprise sending a request for the position of a first mobile device of the positioning group, wherein the first mobile device comprises the leader device, the validator device, or one of the one or more other devices. In such embodiments, sending the request for the position of the first mobile device of the positioning group may occur prior to receiving the indication that the attempt by the leader device to determine the initial position estimate has failed.

Means for performing functionality at block 820 may comprise a bus 1005, processor(s) 1010, communications subsystem 1030 (which may include wireless communications interface 1033), memory 1035, operating system 1040, application(s) 1045, and/or other components of a computer system 1000, as illustrated in FIG. 10 and described in more detail below.

At block 830, the functionality comprises, responsive to receiving the indication that the attempt by the leader device to determine the initial position estimate has failed, initiating a positioning session with the validator device. Means for performing functionality at block 830 may comprise a bus 1005, processor(s) 1010, communications subsystem 1030 (which may include wireless communications interface 1033), memory 1035, operating system 1040, application(s) 1045, and/or other components of a computer system 1000, as illustrated in FIG. 10 and described in more detail below.

FIG. 9 is a block diagram of an embodiment of a mobile device 900, which can be utilized as described herein above (e.g., in association with the previously described figures). For example, the mobile device 900 may be utilized as and/or correspond with mobile, leader, validator, other devices, or a combination thereof, including device(s) 105a and 105b of FIG. 1; devices 240, 250, and 260 of FIG. 2; devices 305, 310, and 315 of FIG. 3; devices 405, 410, and 415 of FIGS. 4A and 4B; devices 505, 510, and 515 of FIGS. 5A and 5B; devices 605, 610, and 615 of FIGS. 6A and 6B; It should be noted that FIG. 9 is meant only to provide a generalized illustration of various components, any or all of which may be utilized as appropriate. Furthermore, the functionality of a mobile device described herein may be executed by one or more of the hardware and/or software components illustrated in FIG. 9.

The mobile device 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The mobile device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The mobile device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile device 900 to communicate with other devices as described in the embodiments above. The wireless communication interface 930 may permit data and signaling to be communicated (e.g., transmitted and received) with transmission/reception points (TRPs) of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile device 900 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements for sensor-assisted positioning and/or other information (e.g., for determining an approximate location of a the mobile device 900, as described herein).

Embodiments of the mobile device 900 may also include a GNSS receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the mobile device 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The mobile device 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the mobile device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the mobile device 900 (and/or processor(s) 910 or DSP 920 within mobile device 900). In some embodiments, then, such code and/or instructions can be used to configure and/or adapt a general-purpose computer (or other device) to perform one or more operations in accordance with the described methods.

FIG. 10 is a block diagram of an embodiment of a computer system 1000, which may be used, in whole or in part, to provide the functions of one or more components and/or devices as described in the embodiments herein, including a server and/or services in the cloud. Thus, the computer system 1000 may be utilized as and/or correspond with a network function server 160, external client 180, location server (220, 320, 420, 520, 620), monitoring device, or any combination thereof, as described herein. This may include, for example, a computer server, personal computer, personal electronic device, or the like. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers that may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network, including a User Equipment (UE), base stations and/or other transmission reception points (TRPs), and/or any other electronic devices described herein. Hence, the communications subsystem 1030 may be used to receive and send data as described in the embodiments herein.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of providing location determination, the method performed at a first mobile device and comprising: communicating with a plurality of mobile devices to form a positioning group, wherein the communicating comprises exchanging positioning capability information with the plurality of mobile devices, and wherein the positioning group comprises: a leader device configured to determine an initial position estimate, a validator device configured to determine a validated position estimate, and one or more other devices different than the leader device and the validator device; and sending an estimated position of the first mobile device to a monitoring device, the estimated position of the first mobile device based at least in part on the initial position estimate, the validated position estimate, or both.

Clause 2. The method of clause 1, wherein communicating with the plurality of mobile devices to form the positioning group comprises determining relative positions of the first mobile device, each mobile device in the plurality of mobile devices, or both.

Clause 3. The method of any one of clauses 1-2 wherein communicating with the plurality of mobile devices is based on sidelink signaling.

Clause 4. The method of any one of clauses 1-3 wherein the leader device and the validator device are respectively selected as the leader device and the validator device of the positioning group based at least in part on respective positioning capabilities of the leader device and the validator device.

Clause 5. The method of clause 4 wherein the validator device is capable of performing more types of positioning methods than the leader device.

Clause 6. The method of any one of clauses 1-5 wherein the first mobile device comprises the leader device, the method further comprising: attempting to determine the initial position estimate; sending, to the validator device, a result of the attempt to determine the initial position estimate; and receiving a validated position estimate from the validator device.

Clause 7. The method of clause 6 wherein the result of the attempt to determine the initial position estimate comprises: the initial position estimate, or an indication that the attempt to determine the initial position estimate has failed.

Clause 8. The method of clause 7 wherein the result of the attempt to determine the initial position estimate comprises the initial position estimate, and the method further comprises: sending the initial position estimate to the one or more other devices, sending the validated position estimate to the one or more other devices, or both.

Clause 9. The method of any one of clause 7 wherein the result of the attempt to determine the initial position estimate comprises the initial position estimate; and sending the result to the validator device is responsive to a determination that a confidence level of the initial position estimate is below a threshold confidence level.

Clause 10. The method of any one of clauses 6-9 further comprising attempting to determine the initial position estimate responsive to receiving a position request from the one or more other devices.

Clause 11. The method of any one of clauses 6-10 further comprising performing a calibration of one or more sensors, one or more algorithms, or both, of the first mobile device based at least in part on the validated position estimate.

Clause 12. The method of any one of clauses 1-5 wherein the first mobile device comprises the leader device, the method further comprising: attempting to determine the initial position estimate; sending, to a location server, a result of the attempt to determine the initial position estimate; and receiving a validated position estimate.

Clause 13. The method of any one of clauses 1-12 wherein the first mobile device comprises the leader device, and wherein, to determine the initial position estimate, the leader device is configured to conduct a positioning session with a location server.

Clause 14. The method of any one of clauses 1-5 wherein the first mobile device comprises the validator device, the method further comprising: receiving, from the leader device, a result of an attempt to determine the initial position estimate; determining the validated position estimate; and sending the validated position estimate to the leader device, the one or more other devices, or a combination thereof.

Clause 15. The method of clause 14 wherein sending the validated position estimate to the one or more other devices is responsive to receiving a position request from the one or more other devices.

Clause 16. The method of any one of clauses 14-15 wherein the initial position estimate is determined using a first positioning method, and wherein determining the validated position estimate comprises using a second positioning method different than the first positioning method.

Clause 17. The method of clause 16 wherein determining the validated position estimate comprises conducting a positioning session with a location server.

Clause 18. The method of clause 16 wherein the result of the attempt to determine the initial position estimate comprises an indication that the attempt to determine the initial position estimate has failed, and wherein the method further comprises initiating the positioning session with a location server responsive to receiving the indication that the attempt to determine the initial position estimate has failed.

Clause 19. The method of any one of clauses 1-5 wherein the first mobile device comprises one of the one or more other devices, and the method comprising sending a position request to the leader device, the validator device, or both.

Clause 20. The method of clause 19 wherein sending the position request: occurs prior to an attempt to determine the initial position estimate by the leader device, or is responsive to receiving a request for the position of the first mobile device from the monitoring device.

Clause 21. The method of any one of clauses 1-20 wherein communicating with the plurality of mobile devices to form the positioning group comprises determining a relative position of the first mobile device relative to the leader device, the validator device, or both, wherein the estimated position of the first mobile device is based at least in part on the relative position of the first mobile device.

Clause 22. The method of any one of clauses 1-21 wherein the monitoring device comprises a location server.

Clause 23. A method of providing location determination, the method performed at a location sever and comprising: receiving an indication of a leader device and a validator device of a positioning group, wherein the positioning group comprises: the leader device configured to determine an initial position estimate, the validator device configured to determine a validated position estimate, and one or more other devices different than the leader device and the validator device; receiving an indication that an attempt by the leader device to determine the initial position estimate has failed; and responsive to receiving the indication that the attempt by the leader device to determine the initial position estimate has failed, initiating a positioning session with the validator device.

Clause 24. The method of clause 23, further comprising sending a request for a position of a first mobile device of the positioning group, wherein the first mobile device comprises the leader device, the validator device, or one of the one or more other devices.

Clause 25. The method of clause 24 wherein sending the request for the position of the first mobile device of the positioning group occurs prior to receiving the indication that the attempt by the leader device to determine the initial position estimate has failed.

Clause 26. A first mobile device comprising: a transceiver; a memory; and one or more processors communicatively coupled with the transceiver and the memory, wherein the one or more processors are configured to: communicate with a plurality of mobile devices, via the transceiver, to form a positioning group, wherein the communicating comprises exchanging positioning capability information with the plurality of mobile devices, and wherein the positioning group comprises: a leader device configured to determine an initial position estimate, a validator device configured to determine a validated position estimate, and one or more other devices different than the leader device and the validator device; and send an estimated position of the first mobile device to a monitoring device via the transceiver, the estimated position of the first mobile device based at least in part on the initial position estimate, the validated position estimate, or both.

Clause 27. The first mobile device of clause 26, wherein, to communicate with the plurality of mobile devices to form the positioning group, the one or more processors are configured to determine relative positions of the first mobile device, each mobile device in the plurality of mobile devices, or both.

Clause 28. The first mobile device of any one of clauses 26-27 wherein, when the first mobile device is selected as the leader device, the one or more processors are configured to attempt to determine the initial position estimate; send, to the validator device or a location server, a result of the attempt to determine the initial position estimate; and receive a validated position estimate from the validator device.

Clause 29. The first mobile device of any one of clauses 26-28 wherein, when the first mobile device is selected as the validator device, the one or more processors are configured to receive, from the leader device, a result of an attempt to determine the initial position estimate; determine the validated position estimate; and send the validated position estimate to the leader device, the one or more other devices, or a combination thereof.

Clause 30. The first mobile device of clause 29 wherein, to determine the validated position estimate, the one or more processors are configured to conduct a positioning session with a location server.

Clause 31. The first mobile device of any one of clauses 26-30 wherein when the first mobile device is selected as one of the one or more other devices, the one or more processors are further configured to send a position request to the leader device, the validator device, or both.

Clause 32. A location server comprising: a transceiver; a memory; and one or more processors communicatively coupled with the transceiver and the memory, wherein the one or more processors are configured to: receive, via the transceiver, an indication of a leader device and a validator device of a positioning group, wherein the positioning group comprises: the leader device configured to determine an initial position estimate, the validator device configured to determine a validated position estimate, and one or more other devices different than the leader device and the validator device; receive, via the transceiver, an indication that an attempt by the leader device to determine the initial position estimate has failed; and responsive to receiving the indication that the attempt by the leader device to determine the initial position estimate has failed, initiating a positioning session with the validator device.

Clause 33. The location server of clause 32, wherein the one or more processors are further configured to send a request for a position of a first mobile device of the positioning group, wherein the first mobile device comprises the leader device, the validator device, or one of the one or more other devices.

Clause 34. The location server of any one of clauses 32-33 wherein the one or more processors are further configured to send the request for the position of the first mobile device of the positioning group prior to receiving the indication that the attempt by the leader device to determine the initial position estimate has failed.

Clause 35. An apparatus having means for performing the method of any one of clauses 1-25.

Clause 36. A non-transitory computer-readable medium storing instructions, the instructions comprising code for performing the method of any one of clauses 1-25.

What is claimed is:

1. A method of providing location determination, the method performed at a first mobile device and comprising:
communicating with a plurality of mobile devices to form a positioning group, wherein the communicating comprises exchanging positioning capability information with the plurality of mobile devices, and wherein the positioning group comprises:
a leader device configured to determine an initial position estimate,
a validator device configured to determine a validated position estimate, and
one or more other devices different than the leader device and the validator device; and
sending an estimated position of the first mobile device to a monitoring device, the estimated position of the first mobile device based at least in part on the initial position estimate, the validated position estimate, or both.

2. The method of claim 1, wherein communicating with the plurality of mobile devices to form the positioning group comprises determining relative positions of the first mobile device, each mobile device in the plurality of mobile devices, or both.

3. The method of claim 1, wherein communicating with the plurality of mobile devices is based on sidelink signaling.

4. The method of claim 1, wherein the leader device and the validator device are respectively selected as the leader device and the validator device of the positioning group based at least in part on respective positioning capabilities of the leader device and the validator device.

5. The method of claim 4, wherein the validator device is capable of performing more types of positioning methods than the leader device.

6. The method of claim 1, wherein the first mobile device comprises the leader device, the method further comprising:
attempting to determine the initial position estimate;
sending, to the validator device, a result of the attempt to determine the initial position estimate; and
receiving a validated position estimate from the validator device.

7. The method of claim 6, wherein the result of the attempt to determine the initial position estimate comprises:
the initial position estimate, or
an indication that the attempt to determine the initial position estimate has failed.

8. The method of claim 7, wherein the result of the attempt to determine the initial position estimate comprises the initial position estimate, and the method further comprises:
sending the initial position estimate to the one or more other devices,
sending the validated position estimate to the one or more other devices, or both.

9. The method of claim 7, wherein:
the result of the attempt to determine the initial position estimate comprises the initial position estimate; and
sending the result to the validator device is responsive to a determination that a confidence level of the initial position estimate is below a threshold confidence level.

10. The method of claim 6, further comprising attempting to determine the initial position estimate responsive to receiving a position request from the one or more other devices.

11. The method of claim 6, further comprising performing a calibration of one or more sensors, one or more algorithms, or both, of the first mobile device based at least in part on the validated position estimate.

12. The method of claim 1, wherein the first mobile device comprises the leader device, the method further comprising:
attempting to determine the initial position estimate;
sending, to a location server, a result of the attempt to determine the initial position estimate; and
receiving a validated position estimate.

13. The method of claim 1, wherein the first mobile device comprises the leader device, and wherein, to determine the initial position estimate, the leader device is configured to conduct a positioning session with a location server.

14. The method of claim 1, wherein the first mobile device comprises the validator device, the method further comprising:
receiving, from the leader device, a result of an attempt to determine the initial position estimate;
determining the validated position estimate; and
sending the validated position estimate to the leader device, the one or more other devices, or a combination thereof.

15. The method of claim 14, wherein sending the validated position estimate to the one or more other devices is responsive to receiving a position request from the one or more other devices.

16. The method of claim 14, wherein the initial position estimate is determined using a first positioning method, and wherein determining the validated position estimate comprises using a second positioning method different than the first positioning method.

17. The method of claim 14, wherein determining the validated position estimate comprises conducting a positioning session with a location server.

18. The method of claim 17, wherein the result of the attempt to determine the initial position estimate comprises an indication that the attempt to determine the initial position estimate has failed, and wherein the method further comprises initiating the positioning session with a location server responsive to receiving the indication that the attempt to determine the initial position estimate has failed.

19. The method of claim 1, wherein the first mobile device comprises one of the one or more other devices, and the method comprising sending a position request to the leader device, the validator device, or both.

20. The method of claim 19, wherein sending the position request:
occurs prior to an attempt to determine the initial position estimate by the leader device, or
is responsive to receiving a request for the position of the first mobile device from the monitoring device.

21. The method of claim 1, wherein communicating with the plurality of mobile devices to form the positioning group comprises determining a relative position of the first mobile device relative to the leader device, the validator device, or both, wherein the estimated position of the first mobile device is based at least in part on the relative position of the first mobile device.

22. The method of claim 1, wherein the monitoring device comprises a location server.

23. A method of providing location determination, the method performed at a location sever and comprising:
receiving an indication of a leader device and a validator device of a positioning group, wherein the positioning group comprises:
the leader device configured to determine an initial position estimate,
the validator device configured to determine a validated position estimate, and
one or more other devices different than the leader device and the validator device;
receiving an indication that an attempt by the leader device to determine the initial position estimate has failed; and
responsive to receiving the indication that the attempt by the leader device to determine the initial position estimate has failed, initiating a positioning session with the validator device.

24. The method of claim 23, further comprising sending a request for a position of a first mobile device of the positioning group, wherein the first mobile device comprises the leader device, the validator device, or one of the one or more other devices.

25. The method of claim 24, wherein sending the request for the position of the first mobile device of the positioning group occurs prior to receiving the indication that the attempt by the leader device to determine the initial position estimate has failed.

26. A first mobile device comprising:
a transceiver;
a memory; and
one or more processors communicatively coupled with the transceiver and the memory, wherein the one or more processors are configured to:
communicate with a plurality of mobile devices, via the transceiver, to form a positioning group, wherein the communicating comprises exchanging positioning capability information with the plurality of mobile devices, and wherein the positioning group comprises:
a leader device configured to determine an initial position estimate,
a validator device configured to determine a validated position estimate, and
one or more other devices different than the leader device and the validator device; and
send an estimated position of the first mobile device to a monitoring device via the transceiver, the estimated position of the first mobile device based at least in part on the initial position estimate, the validated position estimate, or both.

27. The first mobile device of claim 26, wherein, to communicate with the plurality of mobile devices to form the positioning group, the one or more processors are configured to determine relative positions of the first mobile device, each mobile device in the plurality of mobile devices, or both.

28. The first mobile device of claim 26, wherein, when the first mobile device is selected as the leader device, the one or more processors are configured to:
attempt to determine the initial position estimate;
send, to the validator device or a location server, a result of the attempt to determine the initial position estimate; and
receive a validated position estimate from the validator device.

29. The first mobile device of claim 26, wherein, when the first mobile device is selected as the validator device, the one or more processors are configured to:
receive, from the leader device, a result of an attempt to determine the initial position estimate;
determine the validated position estimate; and
send the validated position estimate to the leader device, the one or more other devices, or a combination thereof.

30. The first mobile device of claim 29, wherein, to determine the validated position estimate, the one or more processors are configured to conduct a positioning session with a location server.

31. The first mobile device of claim 26, wherein when the first mobile device is selected as one of the one or more other devices, the one or more processors are further configured to send a position request to the leader device, the validator device, or both.

32. A location server comprising:
a transceiver;
a memory; and
one or more processors communicatively coupled with the transceiver and the memory, wherein the one or more processors are configured to:
receive, via the transceiver, an indication of a leader device and a validator device of a positioning group, wherein the positioning group comprises:
the leader device configured to determine an initial position estimate,
the validator device configured to determine a validated position estimate, and
one or more other devices different than the leader device and the validator device;
receive, via the transceiver, an indication that an attempt by the leader device to determine the initial position estimate has failed; and
responsive to receiving the indication that the attempt by the leader device to determine the initial position estimate has failed, initiating a positioning session with the validator device.

33. The location server of claim 32, wherein the one or more processors are further configured to send a request for a position of a first mobile device of the positioning group, wherein the first mobile device comprises the leader device, the validator device, or one of the one or more other devices.

34. The location server of claim 33, wherein the one or more processors are further configured to send the request for the position of the first mobile device of the positioning group prior to receiving the indication that the attempt by the leader device to determine the initial position estimate has failed.
